(19) United States
(12) Patent Application Publication
(10) Pub. No.: US 2006/0151760 A1
(43) Pub. Date: Jul. 13, 2006

(54) Tensioning system

(76) Inventor: John Theodore Vyvyan-Vivian, Oak Beach (AU)

Correspondence Address: SUMMA, ALLAN & ADDITON, P.A., 11610 NORTH COMMUNITY HOUSE ROAD, SUITE 200, CHARLOTTE, NC, 28277, US

(21) Appl. No.: 10/532,581

(22) PCT Filed: Oct. 27, 2003
(86) PCT No.: PCT/AU03/01419

§ 371 Date: Apr. 25, 2005

(30) Foreign Application Priority Data
Oct. 25, 2002 (AU) 2002952280

(51) Int. Cl. B25B 25/00

(52) U.S. Cl. 254/231

(57) ABSTRACT

A tensioning system comprises one or more cable spacing members (60, 70) with a plurality of cable spacing portions for spacing apart a plurality of runs of cable (10) and a support (40, 50) for supporting the cable spacing member(s) (60, 70). One or more adjustable positioning members (45) for positioning the cable spacing member(s) (60, 70) relative to the support (40, 50) are provided. Adjustment of the one or more adjustable positioning members (45) positions the cable spacing member(s) (60, 70) relative to the support (40, 50) and adjusts the tension in the runs of cable (10). The cable spacing member(s) (60, 70) are preferably provided within the support (40, 50) with the runs of cable (10) extending through a longitudinal slot in the support (40, 50).

### FIELD OF THE INVENTION

The present invention relates to a tensioning system and particularly, but not exclusively, to a tensioning system for use in tensioning cables of a fence.

### BACKGROUND OF THE INVENTION

Tensioned cables have been used in fences as an alternative to use of rigid bars or to help fill in or lessen the size of gaps which occur between structural elements of the fence. In known systems, a tensioning device, which remains permanently connected to the cable, is provided in line with each cable or between each cable and a support. The tensioning devices currently used may be expensive (especially as they are used in large numbers in a single fence) and may be difficult or impossible to tighten to high tensions. They may also have a tendency to loosen over time, and may detract from the aesthetic appeal and simple lines of a fence or barrier. It would therefore be desirable to provide a tensioning system which addresses at least some of these issues or at least provides a useful alternative.

### SUMMARY OF THE INVENTION

According to a first aspect of the present invention, there is provided a tensioning system for tensioning cable comprising:

a cable spacing member with a plurality of cable spacing portions for spacing apart a plurality of runs of cable;

a support for supporting the cable spacing member;

one or more adjustable positioning members for positioning the cable spacing member relative to the support wherein, in use, adjustment of the one or more adjustable positioning members to position the cable spacing member relative to the support adjusts the tension in the runs of cable.

Preferably, adjustment of the one or more adjustable positioning members is adapted to move the cable spacing member in a direction substantially parallel to a longitudinal direction of the runs of cable.

Preferably, each cable spacing portion includes one or more apertures and/or slots in the cable spacing member.

Preferably, respective apertures or slots are spaced apart to space apart respective runs of cable.

The cable spacing portions may include features other than slots or apertures in order to space apart runs of cable. Such other features might include one or more of: hooks; lugs; abutment portions or other configurations adapted to space apart cables.

Preferably, the cable spacing member includes at least three cable spacing portions. In a preferred embodiment, the cable spacing member spaces at least three runs of cable.

Preferably, the cable spacing member includes four or more cable spacing portions.

Preferably, in use, the cable spacing member is located inside the support.

The support may be generally tubular including one or more openings along the length thereof for runs of cable to pass through.

Preferably, the support includes one or more longitudinal slots for cables to pass through.

Preferably, the or each longitudinal slot is long compared to the radial dimensions of the support.

Preferably, the adjustable positioning members are adapted for manual operation.

Preferably, the adjustable positioning members are manually operable by use of a tool. In a preferred embodiment, the adjustable positioning members are operable by an Allen key.

Preferably, at least one of the adjustable positioning members includes a mechanism which provides a mechanical advantage, so that applying an input force to operate the positioning member results in a greater force being applied to move the bar relative to the support.

Preferably, the positioning members include a helically threaded portion.

Preferably, at least one of the adjustable positioning members includes a threaded shaft.

Preferably, at least one of the adjustable positioning members includes a bolt or a bolt-like fastener.

Preferably, at least one adjustable positioning member extends from an external region of the support into an internal region of the support.

Preferably, said at least one adjustable positioning member extends through the cable spacing member.

Preferably, the cable spacing member and the support each include receiving portions for the adjustable positioning members.

Preferably, the receiving portions include apertures for receipt of part of an adjustable positioning member therethrough.

Preferably, the receiving portions are provided so that, in use, each of a plurality of receiving portions provided on the support are substantially aligned with respective ones of a plurality of receiving portions provided on the cable spacing member.

In a preferred embodiment, one or more adjustable positioning members include a threaded shaft, the shaft extending, in use, through an aperture in the support and an aperture in the cable spacing member.

The or each adjustable positioning member is preferably associated with at least two operating portions or attachments which are axially moveable relative to each other by rotation of at least one of the operating portions relative to the adjustable positioning member.

Preferably, relative axial movement of the operating portions forces relative movement of the cable spacing member and the support.

Preferably, one of the operating portions or attachments is a head of a bolt, or bolt-like fastener, which forms at least part of the adjustable positioning member.

Preferably, one of the operating portions is a nut associated with a bolt, or bolt-like fastener, which forms at least part of the adjustable positioning member.

Alternatively, one of the operating portions may be part of the cable spacing member, or a part of the support. In thin case, the part of the cable spacing member or part of the support preferably includes a female threaded portion for cooperation with a threaded shaft of the adjustable positioning member.

One or more of the cable spacing portions may include a contour which extends from a lateral edge of the cable spacing member. The contour preferably comprises a slot, most preferably a laterally extending slot. In a preferred embodiment, lengths of cable can be introduced laterally into the cable spacing portions.

The cable spacing member may include two or more parts, which may be coupled together, in use, to form a single cable spacing member.

If the cable spacing member includes two or more such parts, the parts may be designed so that at least one of the parts is configured to receive lengths of cable into cable spacing portions before coupling with another part to form a single cable spacing member, but so that after coupling, separation of the lengths of cable from the cable spacing member is inhibited by the other part.

The separation of the lengths of cable form the cable spacing portions may be inhibited by preventing egress of cable from the cable spacing portion via the contour or slot.

Each of the parts of the cable spacing member may include contours which extend, in use, from opposite lateral edges of the respective parts, so that when the parts are coupled, lateral egress of the lengths of cable is inhibited.

The features of the tensioning system described above will typically be used for securing and applying a tensioning force to a first end of each run of cable.

Positioning and/or securing means for the second end of each run of cable may include one or more of the features described in relation to the first aspect of the invention.

Preferably, the second ends of respective runs of cable are retained by coupling to a secondary cable spacing member.

Preferably, the secondary cable spacing member includes one or more of the features described above in relation to the (main) cable spacing member.

Preferably, the secondary cable spacing member is provided, in use, inside a secondary support.

According to a second aspect of the present invention, there is provided a barrier including a tensioning system in accordance with the first aspect of the present invention.

Preferably, in use, the barrier forms part or all of a fence or balustrade.

Preferably, the barrier, in use, forms part or all of a pool fence.

Preferably, the barrier includes a support and a cable spacing member for supporting and applying a tensioning force to a first end of each of a plurality of runs of cable, and a secondary support for positioning and/or retaining a second and of each of a plurality of runs of cable.

Preferably, the barrier includes one or more bracing members for bracing apart the support and the secondary support.

According to a third aspect of the present invention, there is provided a method of tensioning a plurality of runs of cable, comprising:

coupling at least one length of cable to a cable spacing member having cable spacing portions thereon for spacing apart a plurality of runs of cable, and coupling said at least one length of cable to a secondary cable spacing member having cable spacing portions thereon for spacing apart a plurality of runs of cable, in order to provide a plurality of runs of cable between the cable spacing member and the secondary cable spacing member;

locating the cable spacing member relative to a support;

providing one or more adjustable positioning members for adjustably positioning the cable spacing member relative to the support;

locating the secondary cable spacing member relative to a secondary support;

adjusting the one or more adjustable positioning members in order to tension the runs of cable.

The sequence of the steps stated in the above statement in preferred, but not essential to the aspect of the invention.

Preferably, adjustment of the one or more adjustable positioning members is the final step in the above method.

Preferably, the method is a method of tensioning a plurality of runs of cable in forming a fence or similar barrier.

Preferably, locating the cable spacing member relative to a support comprises inserting the cable spacing member into a hollow support.

Preferably, the support is generally tubular and is provided with a longitudinal slot through which, in use, runs of cable may extend from the cable spacing member to the outside of the support.

Preferably, the support is a rail of a fence.

Preferably, the secondary support is a rail of a fence.

Preferably, the support is an upper rail of a fence and the secondary support is a lower rail of a fence.

Preferably, the method includes using a spreader device to space apart the support and the secondary support prior to final adjustment of the adjustable positioning members.

Preferably, the method includes insertion of bracing members between the support and the secondary support.

Preferably, the method includes forming a substantially rigid panel comprising a cable spacing member located relative to a support; a secondary cable spacing member located relative a secondary support; a plurality of runs of cable; one or more bracing bars and/or spreader devices bracing apart the support and the secondary support.

Preferably, the method further includes fixing the substantially rigid panel in a desired location by fixing at least one of the support and secondary support in position.

Preferably, the method includes adjustment of the one or mare adjustable positioning members after fixing the substantially rigid panel in said desired location.

Preferably, the substantially rigid panel includes use of one or more spreader devices but no bracing bars prior to fixing of the latter of the support and secondary support in the desired location, and the method includes subsequent insertion of one or more bracing bare between the support and secondary support and removal of the one or more spreader devices.

According to a fourth aspect of the present invention, there is provided a method of tensioning a plurality of cables comprising:

providing a plurality of tensioning mechanisms, each tensioning mechanism including a spacing member for attachment of the end or respective first ends of one or more runs of cable;

connecting one or more ends of one or more runs of cable to each tensioning mechanism;

inserting each tensioning mechanism into a hollow support member;

providing at least one adjustable positioning member to form part of each tensioning mechanism, each adjustable positioning member extending from an outside to an inside of the associated hollow support member and engaging a spacing member, inside the hollow support member so that adjustment of the adjustable positioning member moves the associated spacing member relative to the hollow support in order to adjust the tension in at least one run of cable; and

adjusting adjustable positioning members to adjust tension in at least one run of cable.

According to a fifth aspect of the present invention, there is provided a barrier including a tensioning system for tensioning cable, comprising:

a plurality of runs of cable which run between a first support and a second support;

a plurality of cable tensioning mechanisms, each tensioning mechanism comprising a spacing member for attachment of the end, or respective first ends, of one or more runs of cable, said spacing members being provided within at least one of the supports and wherein each spacing member has at least one associated adjustable positioning member for adjusting the position of the spacing member relative to the support; and
said adjustable positioning member extending from the outside of the associated support to the associated spacing member located within the support so that the tensioning mechanism can be operated from the outside of the support.

The spacing members may all be within the first support.

Alternatively, some spacing members can be within the first support and other spacing members can be within the second support.

Preferably, at least one of the supports is a tubular member with a longitudinal slot through which runs of cable pass.

It will be appreciated that many of the features considered applicable to other aspects of the invention are applicable to the fourth and fifth aspects.

According to a sixth aspect of the present invention, there is provided a spreader device for bracing apart an upper and lower support for supporting runs of cable therebetween, the spreader device comprising:
a spreader body which may be varied in length, the body comprising first and second substantially parallel body members which may move axially relative to each other in order to vary the length of the body;

a lever member pivotally attached to the first body member; and

an engagement portion for allowing the lever member to force the second body member relative to the first body member,
wherein, operation of the lever member provides a mechanical advantage in forcing a predetermined increase in length of the body when the lever is moved from a first position to a second position and wherein the arrangement of the pivot and the engagement portion is such that when the body is at its maximum length, a compressive force between the ends of the body does not tend to force the lever member towards its first position.

Preferably, the spreader device includes an over centre arrangement to prevent said compressive fence from forcing the lever towards its first position.

Preferably, the engagement portion comprises a link which is pivotally attached at a first attachment part to the lever member, and which is pivotally attached at a second attachment part to the second body member.

Preferably, the pivot between the lever member and the link crosses a projected line between (i) the pivot between the link and the second body member, and (ii) the pivot between the lever member and the first body member.

Alternatively, the engagement portion can comprise a cam surface of the lever member and a corresponding cam following surface of the second body member.

### BRIEF DESCRIPTION OF THE DRAWINGS

Preferred embodiments will now be described, by way of example only, with reference to the accompanying drawings, in which:

FIG. 1 is a schematic front elevation of a barrier in the form of a panel of a fence, in which a tensioning system in accordance with an aspect of the present invention is included;

FIG. 2a is a schematic vertical cross-section of part of the fence of FIG. 1, in the plane of the fence panel;

FIG. 2b in a vertical cross-section on B-B of FIG. 2a;

FIG. 2c is a vertical cross-section on C-C of FIG. 2a;

FIG. 3a is a schematic vertical cross-section of a part of a fence of the type shown in FIG. 1 in the plane of a fence panel, in which a variation of the tensioning system illustrated in FIG. 2a in shown.

FIG. 3b is a vertical cross-section on B-B of FIG. 3a;

FIG. 3c is a vertical cross-section on C-C of FIG. 3a;

FIG. 4a is a schematic plan view from below of two parts which, in use, form an element of the tensioning system shown in FIGS. 2a to 3c;

FIG. 4b is an end view of the parts shown in FIG. 4a;

FIG. 4c is a cross-sectional view of elements of FIG. 4a configured for use;

FIG. 5a in a schematic plan view from below of an element of the barrier illustrated in FIGS. 2a to 2c;

FIG. 5b is a cross-section on B-B of FIG. 5a;

FIG. 6 is a schematic partial cross-sectional view of an alternative embodiment of a barrier in the form of a fence, including an embodiment of a tensioning system;

FIG. 7 is a schematic front elevator of a further alternative embodiment of a barrier in the form of a fence;

FIG. 8 is a schematic front elevation of a further embodiment of a barrier in the form of a fence suitable for demarcating a staircase;

FIG. 9 is a schematic front elevation of an alternative to the embodiment of FIG. 8;

FIG. 10 is a cross-sectional view of a further alternative embodiment;

FIGS. 11a and 11b illustrate an embodiment of a spreader device in contracted and extended configurations respectively;

FIGS. 12a, 12b and 12c show a detail of the spreader device of FIGS. 11a and 11b in its contracted configuration, in side elevation, front elevation and partial horizontal cross-section respectively;

FIGS. 13a and 13b show a detail of the spreader device of FIGS. 11a and 11b in its extended configuration in side elevation and front elevation respectively; and

FIG. 14 is a schematic side elevation of an alternative embodiment of a spreader device.

### DETAILED DESCRIPTION OF THE DRAWINGS

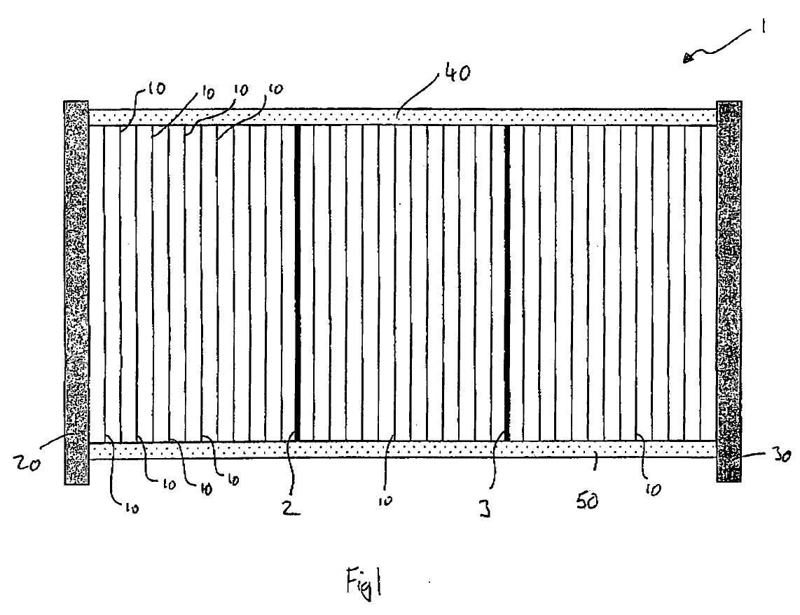

Referring to FIG. 1, an embodiment of a tensioning system in accordance with the present invention is suitable for inclusion in a fence panel, generally designated 1. In use, a preferred embodiment of a fence panel 1 includes vertical bracing bars 2, 3 and vertical end posts 20, 30 which, in use, space apart a substantially horizontal upper support 40 from a substantially horizontal lower support 50. A number of runs of cable 10 extend under tension between the upper support 40 and the lower support 50 in order to provide a barrier which is impassible by objects which are unable to fit through the space between two adjacent runs of cable 10. The use of runs of cable 10 under tension to provide a fence which is, for example, impenetrable to people may be more economical, convenient and/or aesthetically pleasing than use of rigid bars at the same spacing or may provide a desirable alternative.

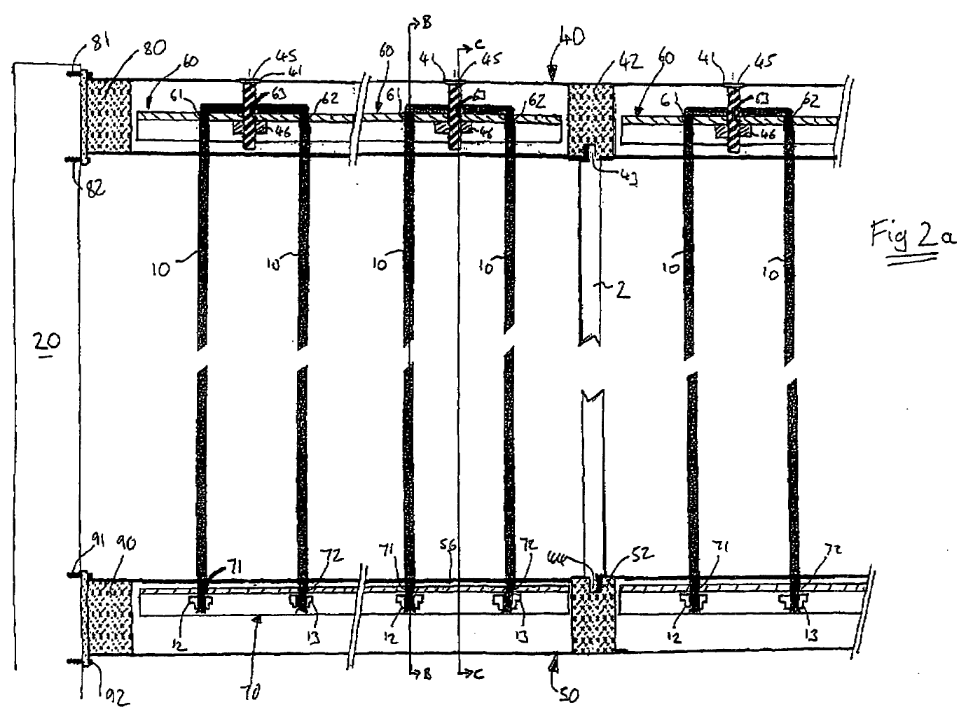

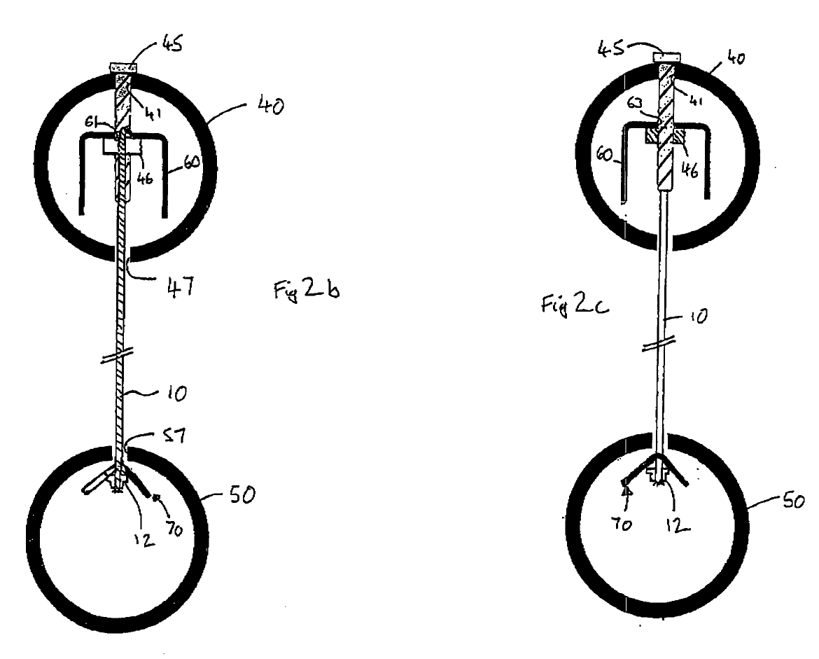

Referring now to FIGS. 2a, 2b and 2c, referred to collectively as FIG. 2, a preferred embodiment of a tensioning system for tensioning the runs of cable 10 in the fence panel 1 will now be described.

As can been seen in FIG. 2, the upper support 40 is tubular and is attached at one end to the first post 20 by a bracket 80 (shown schematically) which is provided with first and second fasteners 81, 82 (in this case in the form of screws) for attachment of the bracket 80 to the post 20. The other end of the upper support 40 is attached by a corresponding bracket (not shown) to the second post 30 (see FIG. 1). Similarly the lower support 50 is tubular and is attached at one end by a lower bracket 90 (shown schematically) and first and second fasteners 91, 92 to the first post 20 and the other end (not shown) of the lower support 50 is attached by a corresponding bracket (not shown) to the second post 30 (see FIG. 1). In a preferred embodiment, at least one of the brackets includes a portion which may move axially relative to an end portion of the support. This allows the bracket to be offered up to a post or other support and moved axially relative to the support, to effectively engage the post or other support.

Provided within the tubular upper support 40, is an upper bar 60 which acts as a cable spacing member and retains a first (upper) end of each run of cable 10. The position of the upper bar 60 can be adjusted to tension the runs of cable 10, as will be described below. Similarly, a lower bar 70 is provided within the lower support 50. The lower bar 70 acts as a secondary cable spacing member, and serves to retain the second (lower) end of each run of cable 10 inside the lower support 50, at a predetermined position. The runs of cable 10 do not attach directly to the upper and lower supports 40, 50 but attach to the upper and lower bars 60, 70.

In the embodiment of FIG. 2, a number of discrete lengths of cable are used and each length of cable forms two runs of cable 10. A given discrete length of cable has a first swaged end 12 retained below the lower bar 70. The cable 10 passes through a first aperture 71 in the lower bar 70 and then out of the lower support 50 extending vertically upwards (under tension) and passing upwardly into the upper support 40. The cable then passes through a first aperture 61 in the upper bar 60, passes horizontally a short distance along the upper bar 60 and then turns downwardly to pass through a second aperture 62 in the upper bar 60 before passing downwardly out of the upper support 40. The cable then extends downwardly until it passes into the lower support 50 and then through a second aperture 72 in the lower bar 70 before terminating in a second swaged end 13 which is retained under the lower bar 70, being too large to fit through the aperture 72. The apertures 61, 62, 71, 72 through which the cables pass act as cable spacing portions of the upper and lower bars 60, 70, retaining the cables in position in the longitudinal direction of the bars 60, 70 and allowing the bars 60, 70 to retain the upper (first) and lower (second) ends of each run of cable 10.

A number of lengths of cable are provided to form a fence panel, and each may be similar to the length of cable described. In the embodiment of FIG. 1, thirty-six runs of cable 10 are provided, these being formed by eighteen lengths of cable, each forming two vertical runs. Of course, in alternative embodiments, each length of cable provided may form one or more vertical runs so that in one extreme, each vertical run of cable 10 is formed by a discrete length of cable, and in the other extreme, all the vertical runs of cable 10 provided in a fence or panel may be provided by a single continuous length of cable.

In the embodiment shown in FIG. 2, it can be seen that the upper bar 60 is retained within the upper support 40 (which in generally tubular in form) and is supported relative to the upper support 40 by a number of adjustable positioning members in the form of bolts 45. Each bolt 45 has a head which remains generally external (although it may be counter-sunk) to the upper support 40. The bolts are preferably of a type that have heads which can be generally flush with the support. Allen bolts are preferred. For security and to help avoid tampering, bolts requiring specific tools to operate them, and having configurations different to the standard hexagonal configuration of an Allen bolt, may be used. Each bolt 45 further has a threaded shaft portion which extends through an aperture 41 in the upper support 40, through a bolt aperture 63 in the upper bar 60 and is retained by a nut 46 on the underside of the upper bar 60. Each nut is preferably retained in position relative to the upper bar 60 even when the bolts 35 are not in place by clips (not shown). Suitable retaining clips are known per se and may be maintained in position by engagement with the portions of the bar defining and surrounding the apertures 63. Alternative means of retaining nuts 46 relative to the upper bar 60 will be apparent to the person skilled in the art, for example welding is an option. As a further, although not preferred, option (and if the thickness of the upper bar 60 is adequate) the nuts may be omitted and a thread may be provided on the internal surface of the apertures 63.

The upper bar 60 can be moved relative to the upper support 40 by adjustment of the bolts 45. This in turn will move the upper (first) ends of each run of cable 10, since the upper end of each run is in engagement with the upper bar 60. Tightening the bolts 45 will force the upper bar 60 upwards, and thus increase the tension in the runs of cable 10.

The lower bar 70 is retained in the lower support 50. The lower bar 70 is elongate and has generally V-shaped cross-section with both limbs of the V-shape approximately the same length. In use, the angle between the limbs points substantially vertically upwards and the V-shaped cross-section helps retain the swaged ends in position. The lower bar 70 will be described in more detail with reference to FIG. 5a and 5b but, as can be seen from FIG. 2a, includes several pairs of cable spacing portions in the font of first and second apertures 71, 72. In use, each aperture 71, 72 retains a lower end of a run of cable 10 (the lower ends correspond to the first and second swaged ends 12, 13 of a length of cable) in a predetermined longitudinal position, and prevents the swaged ends from moving significantly in the axial direction of the cables under the influence of tension in the cable.

In this embodiment, adjustment members are not provided for adjusting the position of the lower bar 70 relative to the lower support 50 but it will be appreciated that adjustment members for moving the lower bar 70 relative to the support could be included if required.

In use, each run of cable 10 is maintained under tension and in a predetermined position by the upper and lower bars 60, 70.

The bracing bar 2 extends between the upper support 40 and the lower support 50 and is provided at its upper end with a pin portion 43 which extends into the upper support 40 and is located in an aperture provided in an upper support block 42 for the bracing bar. The lower end of the bracing bar 2 terminates in a lower pin portion 44 which extends into the lower support 50 and is located in an aperture provided in a lower support block 52. In use, the bracing bars 2, 3 are securely held, under compression, between the upper and lower supports 40, 50 and the upper and lower support blocks 42, 52.

As can be best seen in FIGS. 2b and 2c, the upper support 40 and the lower support 50 are generally tubular, facilitating their accommodating of the upper and lower barn 60, 70. In a preferred embodiment, the upper and lower supports 40, 50 are generally cylindrical, although other box sections or partial box sections could be used. FIG. 2b shows a cross-section through a run of cable 10 (and so that the bolt 45 can be seen in the background) and FIG. 2c shows a cross-section through a bolt 45 (so that a run of cable 10 can be seen in the background).

The upper support 40 has a longitudinal slot 47 which extends the entire length of the upper support 40 and which facilitates assembly of the fence panel 1. Similarly, the lower support 50 has a longitudinal slot 57 extending along its length. The longitudinal slot 47 is at the bottom portion of the upper support 40, and the longitudinal slot 57 is at the upper portion of the lower support 50, so that the lengths of cable 10 each pass through the longitudinal slots 47, 57 and need not contact the upper and lower supports 40, 50 (although, in use, they may do so).

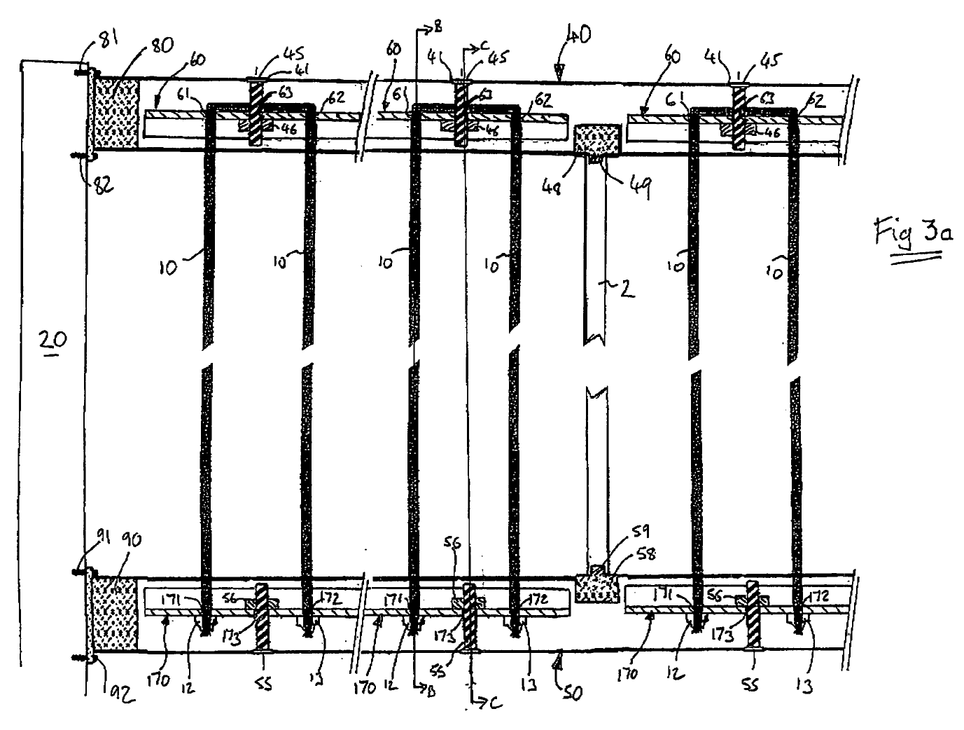

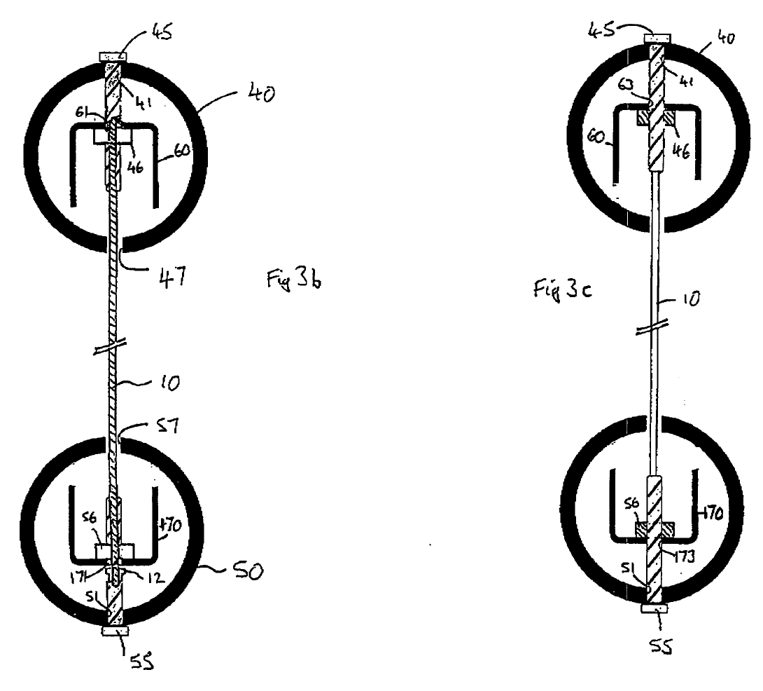

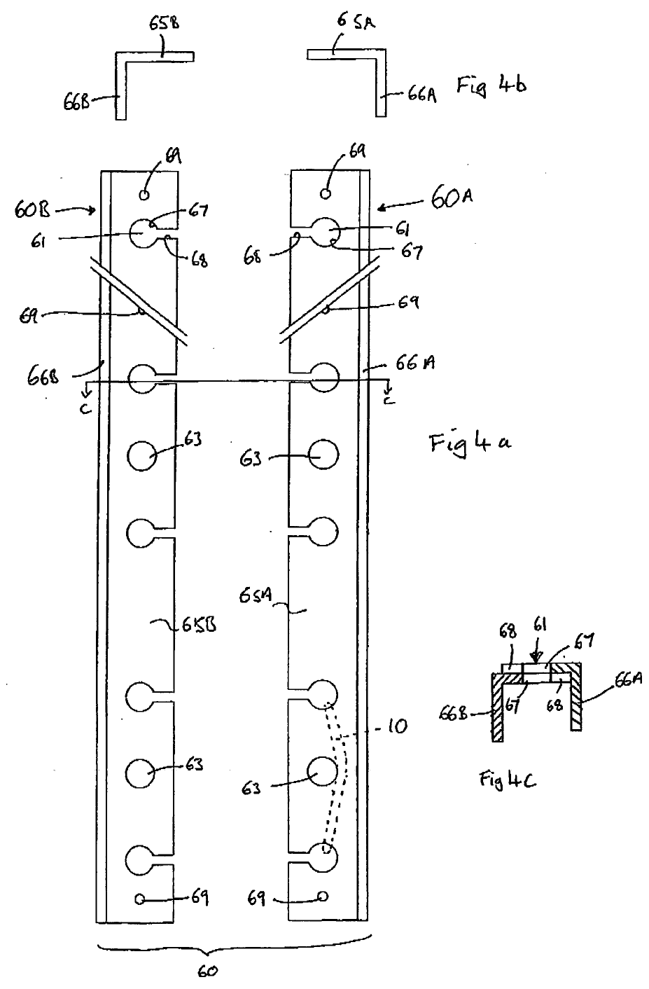

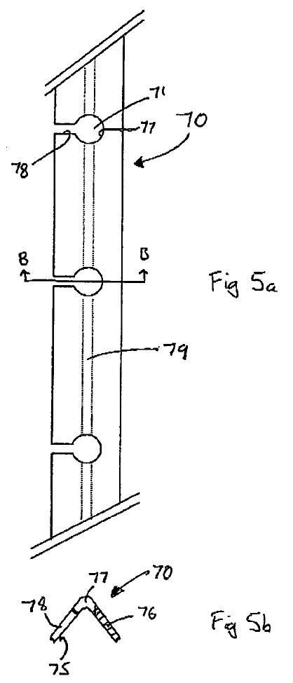

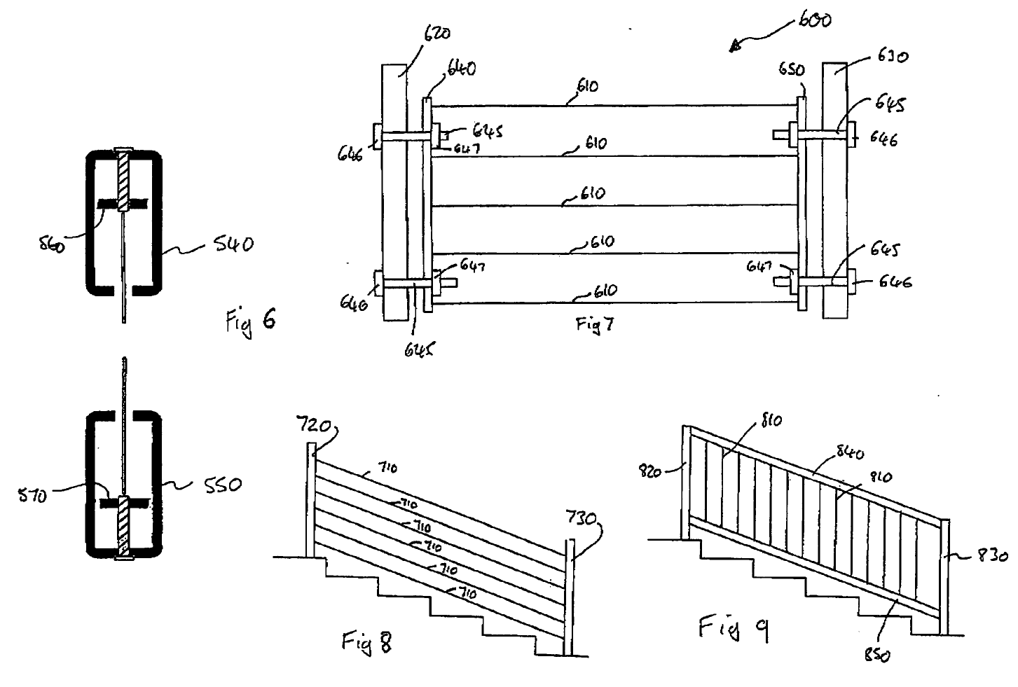

The upper bar 60 in of generally C-shaped cross-section. This allows the upper bar 60 to have the desired degree of rigidity and resilience (discussed hereafter) while being made from a relatively thin sheet of metal. The upper member 60 is for clarity, shown only schematically in FIGS. 2b, 2c, 3b and 3c but will be described in more detail with reference to FIGS. 4a, 4b and 4c.

It will be appreciated that in an alternative embodiment, as illustrated in FIGS. 3a to 3c, a lower bar 170 may be configured and mounted in the lower support 50 in an analogous fashion to the configuration and mounting of the upper bar 60 in the embodiment of FIGS. 2a to 2c. This embodiment will be described with reference to FIGS. 3a to 3c, although because of the similarities to the embodiment of FIG. 2a to 2c, only the differences will be described in detail and elements a corresponding to those in FIGS. 2a to 2c will be designated by the same reference numerals as are used in FIGS. 2a to 2c.

In the embodiment of FIGS. 3a to 3c, a lower bar, designated 170, is generally C-shaped in cross-section. In this embodiment position adjustment members in the form of bolts 55 are provided with their heads external and below the lower support 50 and threaded shafts extending through respective apertures 51 in the lower support, through respective bolt apertures 173 in the lower bar 170 and engaging with respective nuts 56 which are captive on the lower bar 170. The lower bar 170 is provided with cable spacing portions in the form of cable apertures 171, 172, which function generally analogously to the apertures 71, 72 in the embodiment of FIG. 2. Tightening of the bolts 55 will move the lower bar 170 downwards relative to the lower support 50, increasing the tension in the runs of cable 10. The bolts 55 associated with the lower support 50 are examples of adjustable positioning members for positioning the bar 170 in order to allow tensioning of the cable 10. Thus, the embodiment of FIGS. 3a, 3b and 3c is similar in use to the embodiment of FIGS. 2a, 2b and 2c, but because the position of the lower bar 171 relative to the lower support 50 may be adjusted, more scope to adjust the tension in the runs of cable 10 is provided.

This embodiment also includes a variation in the way the bracing bars 2, 3 are retained between the upper and lower supports 20, 30. Rather than being supported by blocks within the supports, in this embodiment each bracing bar is retained top and bottom by respective upper and lower retaining plates 48, 58. Each retaining plate 48, 58 is generally saddle shaped to conform to the curvature of the tubular upper and lower supports and includes a central lug 49, 59 respectively which extends, in use, into an internal bore of the bracing bar 2. An upper concave surface of the upper retaining plate 48 abuts the lower convex surface of the upper support 40, a lower concave surface of the lower plate 58 abuts the upper surface of the lower support 50, and the bracing bar 2 is held, in compression, therebetween and retained by the lugs 49, 59. Use of retaining plates 48, 58 external to the supports 40, 50 (rather than internal blocks) facilitates assembly and allows placement of bracing bars independent of the positioning of the upper and lower bars 60, 70. Each retaining plate may have, but need not have, a central longitudinally extending ridge (not shown) to fit into and locate the retaining plates relative to the longitudinal slots 47, 57 of the supports 40, 50. The retaining plates are shown schematically in FIG. 3a, even though they would not be apparent in a true cross-section. Further variations for mounting the bracing bars between upper and lower supports so that they are securely located under compression are possible, for example, if desired one or more, projections for extending into a longitudinal slot or retaining plates may be included as a single unit with each bracing bar.

Referring now to FIGS. 4a and 4b, a generally C-shaped upper bar 60 an shown schematically in FIGS. 2b, 2c, 3b and 3c may be formed from two parts in the form of two elongate members 60A, 60B each generally L-shaped in cross-section and each having an elongate generally flat rectangular machined section 65A, 653 with a respective elongate flange section 66A, 66B depending from a longitudinal edge thereof. The machined sections 65A, 65B include a number of machined apertures therein for fulfilling various functions, namely: facilitating attachment of the runs of cable 10 thereto; facilitating attachment of the two elongate members 60A, 60B to each other; and connecting bolts 45 (or other adjustable positioning members) thereto.

In order to accommodate cables 10, each machined section 65A, 65B includes a number of apertures 61 for receiving and retaining runs of cable 10. Each of the apertures 61 includes a part circular portion 67 which has a centre which lies on or adjacent a central axis of the machined section 60A, 60B. Each aperture 61 also includes a slot portion 68 which extends between the part circular portion 67 and the lateral edge (of the machined section 65A, 65B) which is distal from flange section 66A, 66B. A cable can thus be fed into the part circular aperture portion 67 by passing a central part of the cable laterally through the slot portion 68—an operation which is less difficult than threading a cable axially through an aperture, and which allows intermediate portions of cables with pre-swaged ends to be inserted into apertures 61. Of course, in a variation, circular apertures could be provided requiring axial threading of a cable therethrough, but such a variation is not preferred. Apertures 62, as shown in FIGS. 2a and 3a, are essentially the same in configuration an apertures 61 and need not be detailed herein.

The machined sections 65A, 65B also include bolt apertures 63 to receive the bolts 45 or other adjustable positioning members and further include connection apertures 69 for facilitating connection of the elongate members 60A, 60B to each other.

FIG. 4c is a cross-sectional view, on C-C of the elements of FIG. 4a in an alternative configuration, illustrating the configuration of the upper bar 60, in use, and showing how, when they are coupled together, the elongate members 60A, 60B form an upper bar 60 with apertures 61 which do not allow a cable (not shown) to exit laterally from the aperture 61 to a side of the upper bar 60 because the part circular portions 67 align but the slot portions 68 extend in opposite lateral directions.

Although the elongate members have been described with reference to the upper bar 60, it will be appreciated that in the embodiment of FIGS. 3a, 3b and 3c the lower bar 170 is formed in a similar way, and indeed in this embodiment the upper bar 60 and lower bar 170 are identical in construction.

By way of illustration, the representation of part of a length of cable which runs horizontally along the upper bar 60 is provided in broken lines, and shows how the cable, in use, runs between two cable apertures, and passes around, for example, the shaft of a bolt 45 (not shown in FIG. 4a). In use, when the runs of cable 10 are tensioned, the cable may bear upon the bolt shaft, but during assembly the cable does not significally impede insertion of a bolt 45 into a bolt aperture 63 because there is little or no tension in the cable.

FIGS. 5a and 5b illustrate a length of the lower bar 70 of FIGS. 2a, 2b and 2c. The lower bar 70 includes a number of apertures 71 (and apertures 72 are effectively identical and will not be described in detail).

Each aperture 71 includes a partial circular portion 77 and a slot portion 78 which connects the circular portion to an opening in a lateral side of the bar 70.

The lower bar 70 is substantially V-shaped in cross-section, as best seen in FIG. 5b, including a first limb 75 in which the slot portions 78 are provided and a second limb 76 which depends substantially perpendicular from the first limb 75. The first and second limbs 75, 76 meet at a central fold portion 79 which extends along the entire length of the lower bar except where it is broken by the apertures 71.

In a preferred embodiment, the cable 10 is formed of 316 grade stainless steel multi-strand cable with a 3 mm diameter. The slot portions 78 may be of a width fractionally less than the equilibrium diameter of the cable, allowing the cable to be manually inserted, but helping to avoid inadvertent egress of the cable from the part circular aperture portions 77 even when the cable is not under tension. In such an embodiment, the members which form the upper bar 60 and lower bar 70, 170 are preferably made from folded and punched 1.6 mm 316 grade stainless steel sheet. In this embodiment also the slotted apertures are spaced at 75 mm intervals along the longitudinal length of the upper and lower bars 60, 70, 170. The bolts 45, 55 which constitute adjustable positioning members are preferably M6 size. The pipe section which forms the upper and lower supports is preferably of 50 mm outside diameter and has a 3 mm wall thickness. Upper and lower supports 40, 50 and upper and lower bars 60, 70, 170 may be manufactured and/or provided in any required lengths and may, if required, be cut to length either in advance or on site. Of course, many variations and alternative embodiments of the described embodiment are possible.

In assembling a fence panel as shown in FIGS. 2a, 2b and 2c the following procedure may be used. (The procedure for assembling the embodiment of FIGS. 3a, 3b and 3c will be apparent from this description and will not be described in detail.) Vertical supports, for example, posts 20, 30 are installed with a spacing between them suitable for fitting of upper and lower supports 40, 50. (Alternatively, lengths of the upper and lower supports are cut according to the spacing of vertical supports.) Cable is attached to upper and lower bars 60, 70 by feeding appropriate lengths of cable 10 (with pre-swaged ends 12, 13) laterally into one of the members 60A, 60B of the upper bar 60, placing the other member of the upper bar 60 laterally over the cables 10 so that the two parts (with generally L-shaped cross-section) which constitute the members 60A, 60B of the upper bar 60 together form an upper bar 60 with a generally C-shaped cross-section. The members 60A, 60B of the upper bar 60 are then secured together, for example by riveting, screwing or bolting through the fastening apertures 69, see FIG. 4a. The cables are attached to the lower bar 70 by sliding lengths of cable laterally, via the slot portions 78 into the part circular aperture portions 77.

The upper bar 60 (or upper bars since a plurality of bars can be used, if desired, in a single upper support) is inserted into the upper support 40 with upper parts of the runs of cable 10 being slid laterally along the longitudinal slot 47. Support blocks 42 for bracing bars 2, 3 may also be inserted into the upper support 40 at this stage (and my be inserted longitudinally between two upper bars 60). Resting the upper support 40 on a stand may facilitate insertion of the upper bar 60 into the upper support 40.

Bolts 45 are inserted through apertures 41 in the upper support 40 and into apertures 63 of the upper bar 60 so that they reach nuts 46. The bolts 45 are rotated enough to engage them in the respective nuts 46 and couple the upper bar 60 to the upper support 40. It will be appreciated that the spacing of apertures 41 along the upper support 40 corresponds to the spacing of apertures 63 on the upper bar 60. Thus, the upper bar 60 is secured in the upper support 40 with the runs of cable 10 able to hang downward out of the upper support 40 through the slot 47.

The one or more lower bars 70 are inserted substantially axially into the lower support 50 in a similar manner. Blocks 52 for bracing bars 2, 3 may also be inserted into the lower support 50 at this time.

The upper support 40 is then fixed to the posts 20, 30 at the desired height by use of suitable fixings such as brackets 80. The stand (not shown) mentioned above, may facilitate offering up the brackets 80 to the posts 20, 30.

The lower support 50, containing the lower bar 70 will, at this stage, be hanging from the upper support 40 by the runs of cable 10. One or more spreader tools are then inserted between the upper support 40 and the lower support 50. The purpose of the spreader tools is to space apart the upper and lower supports 40, 50 to a predetermined distance thus providing a degree of tension in the runs of cable 10 and both spacing and aligning the lower support 50 relative to the upper support 40. (Devices, such as jacks, suitable for spacing apart two objects are known, but an example of a spreader device developed in conjunction with a tensioning system for a fence will be described hereafter.) The panel may then be regarded as substantially rigid, despite the relatively low tension in the runs of cable, since the spreader devices are securely positioned. The lower support is then fixed to the posts 20, 30 using appropriate brackets 90.

The upper and lower supports 40, 50 may then, if required, be spaced slightly further apart by one or more spreader tools so that bracing bars 2, 3 can be inserted between the upper and lower supports 46, 50. In the embodiment of FIG. 2a, the pin portions 43, 53 of the bracing bars 2, 3 would extend into the longitudinal slots 47, 57 of the upper and lower supports 40, 50 and be retained in the blocks 42, 52. Other forms of securing the bracing bars, such as that described above with reference to FIG. 3a are possible. In a preferred embodiment, the bracing bars 2, 3 are 22 mm outside diameter 316 grade stainless steel tubes and are placed at intervals of 900 mm along the length of the upper and lower supports 40, 50.

The spreaders are then released and removed from the panel 1.

At this stage of the assembly process, the fence panel 1 is almost complete and there is some tension in the runs of cable 10. However, for many applications a greater tension is required and in the described embodiment the tension of the runs of cable 10 can easily be increased by use of the bolts 45 to adjust the position of the upper bar 60. Further adjustment of the tension a few months after installation may be desirable. It will be appreciated that the helical thread provided on standard bolts provides a considerable mechanical advantage in converting a force used to rotate the bolt into an axial force between, for example, the bolt and a nut. This mechanical advantage allows a considerable tension to be applied to the cables without difficulty. In the preferred embodiment, the bolts are tensioned to a torque of between 1.0 Nm and 1.5 Nm and this provides considerable tension in the runs of cable 10. The system is also advantageous in that because the tension in the cables is determined by the amount of torque applied to the bolts, a predetermined torque will provide a predetermined tension. Thus, use of a torque limiting tool such as a torque wrench makes it easy to apply a predetermined tension to the cables. Alternatively, an Allen key (or Allen wrench) may be provided with a handle of a length which facilitates manual tightening up to but not beyond, the desired torque. Typically, this will require an Allen key with a short handle to restrict the torque applied.

The barrier or fence panel is thus provided using pre-cut and pre-swaged lengths of cable of approximate length, and bracing bars 2, 3 of predetermined length which must, of course, be consistent with the length of the cable.

It will be appreciated that many variations or alternative embodiments are possible, for example as shown in FIG. 6 the upper and lower supports need not be generally circular in cross-section but may be box section supports such as an upper box section support 540 and a lower box section support 550 which are generally rectangular in radial cross-section. Further in the embodiment of FIG. 6, the upper bar 560 and the lower bar 570 do not have a generally C-shaped or V-shaped cross-sections but are generally planar bars with appropriate apertures and/or slots provided therein. However, the bars shown in FIGS. 4 and 5 are preferred and are structured so that there is a degree of resilience or springiness in the bars 60, 70, 170. This helps to provide substantially uniform tension to the cables attached to the bar even if there are small variations in the length of cable. Of course, it will be appreciated that the discrete lengths of cable used should be of compatible lengths with each other assuming the supports are parallel, that is, each run of cable must be approximately the same length. Embodiments in which the supports are not parallel are also envisaged, and in this case, different runs of cable mast have suitably varying lengths. It will also be appreciated that in an embodiment of one aspect, each bar could be attached to only one run of cable, such an embodiment is not preferred but could still provide the benefit of concealing the tensioning mechanism within a support.

In some embodiments the runs of cable need not be vertical and in some embodiments the bars my be external to the supports. In some embodiments, the (tubular) supports may be curved, and the bars may be relatively short in length, or may themselves be curved, so that they may be accommodated adjacent (or within) the curved supports.

FIG. 7 shows schematically a portion of a fence generally designated 600 in which runs of cable 610 extend horizontally between horizontally spaced apart cable spacing members in the form of bars 640, 650. In the illustrated embodiment, the first and second bars 640, 650 are external to their respective first and second supports 620, 630. Each of the first and second bars 640, 650 is attached to a support by adjustable positioning members in the form of schematically represented bolts 645 each bolt having a head 646 on an external side of its respective support 620, 630 and a nut 647 on the internal side of its respective bar 640, 650. It will be appreciated that an embodiment similar to that of FIG. 7 but with first and second bars located inside hollow (e.g. tubular) supports could be provided. In this case, the supports could each include a longitudinal (axial) slot to allow the runs of cable to pass therethrough, and to facilitate insertion of the bars into the associated supports.

The runs of cable may be orientated in any desired direction between suitably spaced apart cable spacing members and FIG. 8 illustrates the provision of inclined runs of cables 710 between a first support 720 (with a cable spacing member such as a bar, not shown, provided therein) at the top of a flight of stairs and a second support 730 (with a cable spacing member such as a bar, not shown, provided therein) at the bottom of the flight of stairs. Thus, in this embodiment both the supports and the bars are substantially vertical and the cables 10 are inclined.

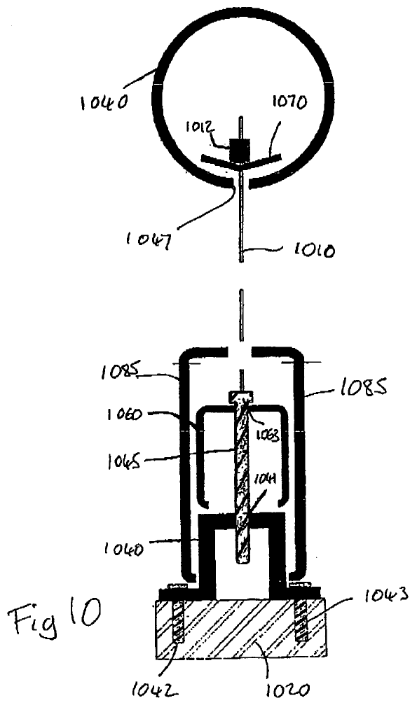

A further alternative, illustrated in FIG. 9 is an embodiment in which an inclined first upper support 840 and an inclined second lower support 860 each include respective cable spacing members to which cables 810 are attached. The supports 830, 840 and the cable spacing members therein are inclined between upper and lower posts 820, 830 respectively to form a barrier demarcating a flight of stairs. In this embodiment therefore, the cable spacing members and supports are inclined but the runs of cable 810 are substantially vertical, running between vertically spaced apart apertures in the bars. It will be appreciated that for aesthetic reasons, embodiments in which the runs are not parallel could be provided; for example by providing different aperture spacing on upper and lower bars.

FIG. 10 illustrates a further embodiment. In this embodiment, a tubular cylindrical upper support 1040 which can act as a hand rail and which includes a longitudinal slot 1047, is provided with an upper bar 1070 therein. The upper bar 1070 acts as a secondary cable spacing member. The upper bar 1070 may be substantially identical to the lower bar 70 of FIGS. 2a, 2b, 2c, 5a and 5b and retains swaged ends 1012 of one or more lengths of cable which form runs of cable 1010. A lower bar 1060, which acts as a cable spacing member and which may be substantially identical in form to the upper bar 60 of FIGS. 2a, 2b, 2c, 3a, 3b, 3c, 4a, 4b and 4c retains the lower ends of the runs of cable 1010. A support 1040 including spaced apart internally threaded apertures 1041 is attached to substrate 1020, such as the floor, for example by bolts 1042, 1043. Adjustable positioning members, for example in the form of bolts 1045, extend through apertures 1063 in the lower bar 1060 in order to adjustably position the lower bar 1060 relative to the support 1040. The runs of cable 1010 may be tensioned by operation of the bolts 1045. If desired, one or more dress covers 1085 may be provided to mask the tensioning mechanism and to provide an aesthetic finish. In a further variation, a separately manufactured lower support 1040 need not be provided and the bolts 1045 may instead be operatively engaged with a suitable substrate or preferably with female threaded sleeves provided therein, for cooperation with the bolts 1045. In this case, the substrate, such as the floor, acts as a support for the cable spacing member (bar 1060).

Although multistrand stainless steel cable is described, cable of any suitable composition may be used.

It is preferred that at least two adjustable positioning members are provided for the cable spacing member (such as bar 60). Still more preferably, three or four positioning members may be provided. In the preferred embodiment, an adjustable positioning member is provided for each two runs of cable. In alternative embodiments, an adjustable positioning member could be provided for each three, four or more runs of cable.

Embodiments of the invention are particularly suitable for pool fencing. In this application, it is important that passage of children between runs of cable should be prevented, and the easily attainable and adjustable high tension provided in the runs of cable of a suitable embodiment makes it effectively impossible for a child to push apart two adjacent runs of cable.

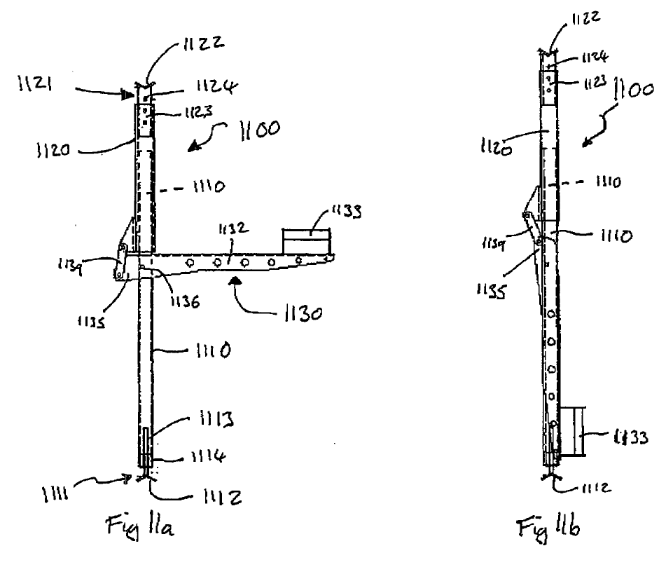

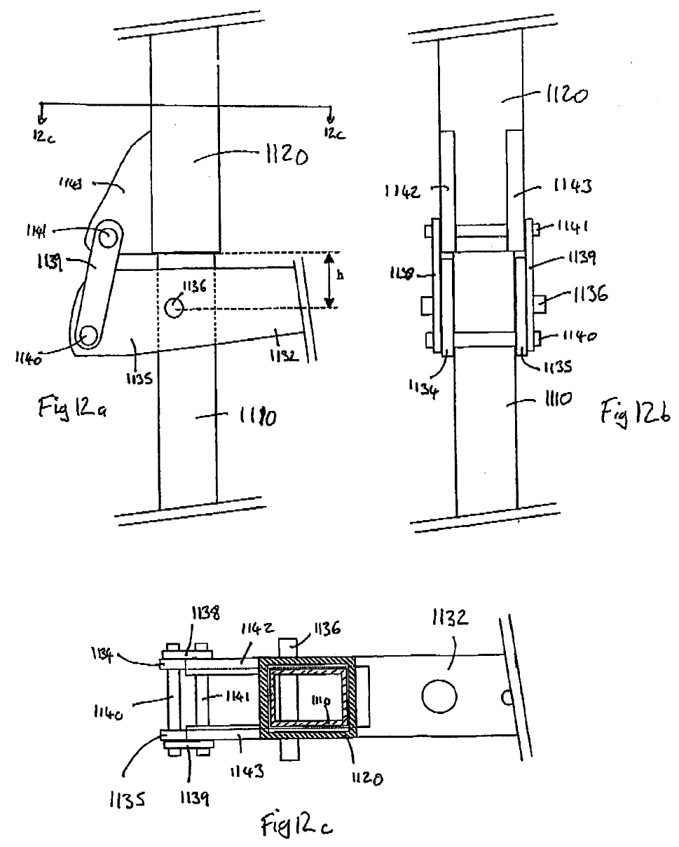

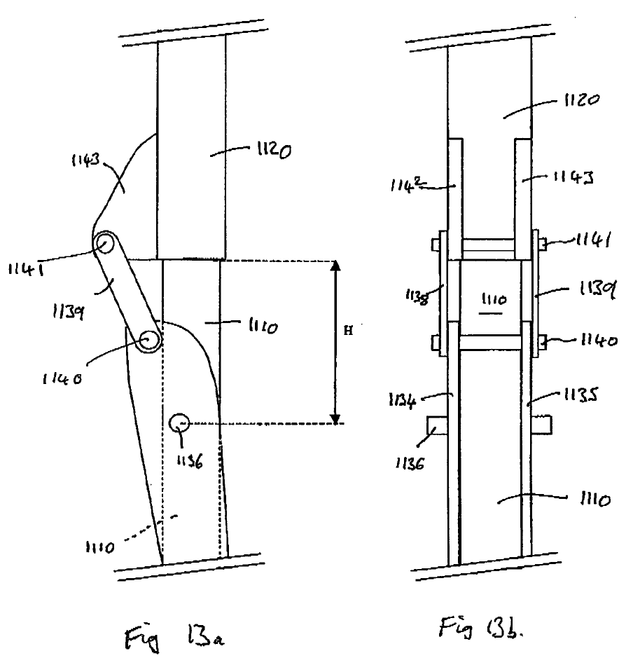

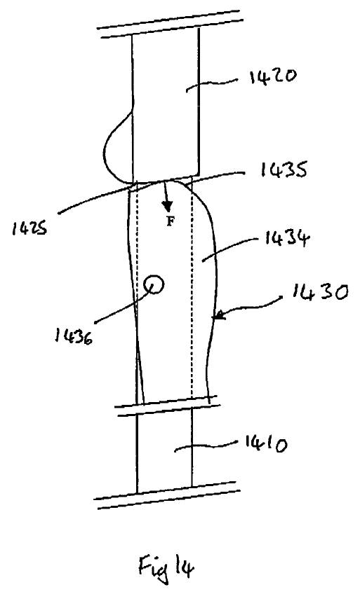

Although in the described embodiments, apertures are used on the bars in order to space apart the runs of cable, other means of spacing apart the runs of cables could be used for example, suitable indentations in the bars, suitable lugs or hooks or the like could be used FIGS. 11a to 13b illustrate a preferred embodiment of a spreader device suitable for use with, for example, the embodiments of FIGS. 1 to 3. A spreader device, generally designated 1100, has a first shorter configuration, illustrated in FIGS. 11a, 12a, 12b and 12c and a second extended configuration, illustrated in FIGS. 11b, 13a and 13b. The extended configuration in a predetermined distance longer than the shorter configuration, and the length of the extended configuration corresponds to the desired distance between, for example, upper and lower supports of a fence of the type illustrated in FIGS. 1 to 3. The spreader device 1100 can thus be inserted between the upper and lower supports in its shorter configuration, and operated to extend it to its extended configuration in order to space apart the upper and lower supports and provide some tension in the runs of cable which extend therebetween. The upper and lower supports can be fixed in place as desired and one or more brace bars added (if required) before the spreader device is operated again to contract it to its shorter configuration, for removal.

The spreader device comprises parallel and, in this embodiment, co-axial first and second elongate body portions 1110, 1120. The body portions 1110, 1120 are made of box section metal, the first body portion 1110 having a slightly smaller cross-section so that a sliding end portion can fit and slide within a sliding end portion of the second body portion 1120. At a distal and of the first body portion 1110 is provided a first location element 1111 for contact with, for example, a lower support of a fence. The first location element 1111 includes a contact portion 1112 which is generally V-shaped in cross-section so that the “arms” of the V can locate the spreader device relative to a circular cross-section bottom support. The first location element further includes a stem portion 1113 which connects the contact portion 1112 to the first body portion 1110. In a preferred embodiment, the stern portion includes an external thread allowing it to be connected to an end plate or end block 1114, located at the end of the first body portion, which includes a threaded aperture (not shown).

At a distal end of the second body portion 1120 is provided a second location element 1121 for contact with, for example, an upper support of a fence. The second location element 1126 includes a contact portion 1122 which is generally V-shaped in cross-section so that the “arms” of the V can locate the spreader device relative to a circular cross-section top support. The second location element further includes a stem portion 1123 which connects the contact portion 1122 to the second body portion 1120. In a preferred embodiment, the stem portion is a length of square box section of similar cross-section to the first body portion 1110 so that it can extend into the end of the second body portion 1120. The stem portion 1123 may include a plurality of apertures 1124 which may be located relative to one or more apertures (not shown) adjacent the end of the second body portion 1120 by one or more pins, bolts or the like. The apertures 1124 allow a user to determine how far the second location element extends from the second body portion 1120.

The spreader device 1100 further includes a lever member 1130 to allow operation of the device. The lever member 1130 includes a main arm 1132. The main arm 1132 is made from C-section steel and is provided with a handle portion 1133 at a first end thereof. Towards the second end of the lever member 1130, the main arm divides into substantially parallel first and second side plates 1134, 1135 which pass either side of the first body portion 1110. The side plates 1134, 1135 are pivotally coupled to the first body portion 1110 by a main pivot pin 1136 which passes through both side plates 1134, 1135 and the first body portion 1110, so the lever member 1130 is pivotally attached to the first body portion 1110. The side plates 1134, 1135 extend from the main arm 1132 a short distance past the first body portion 1110. First ends of first and second links 1138, 1139 are pivotally attached to the ends of the side plates 1134, 1135 by a first pivot pin 1140. Second ends of first and second links 1138, 1139 are pivotally attached by a second pivot pin 1141 to generally triangular plate-like lugs 1142, 1143 which are rigidly attached to the second body portion 1120, and which extend therefrom generally parallel to the side plates 1134, 1135.

The lever member 1130 in pivotable about the main pivot 1136 between a first position in which it is generally perpendicular to the first and second body portions, as illustrated in FIGS. 11a, 12a, 12b, 12c and a second position in which it is generally parallel to the first and second body portions, as illustrated in FIGS. 11b, 13a and 13b. In the second position, the main arm may fit around part of the first body portion.

In the first position, see e.g. FIG. 12a, the lower end of the second body portion 1120 is close to the side plates 1135 (and 1136, not shown in FIG. 12a). It will be appreciated that, as illustrated in FIG. 12a, the lever could be rotated about another 15 degrees anti-clockwise until contacting the bottom of the second body portion 1120, and that this could serve to contract the device slightly.

As the handle portion 1133 is forced downwards to pivot the lever member 1130 towards its second position, the first pivot pin 1140, links 1138, 1139, second pivot pin 1141, lugs and thus the second body portion 1120 are forced upwards (as illustrated) relative to the first body portion 1110, towards the position shown in FIG. 13a. The vertical distance between the main pivot pin 1136 and the bottom of the second body portion is indicated for clarity as “h” in FIG. 12a and as “H” in FIG. 12b. The extension in length of the device, when the lever member is moved from its first to second positions in the difference between these distances (i.e. H−h). This distance is predetermined by the geometry of the device, so the device may be manufactured and set to be a predetermined length in its extended configuration. In relation to the embodiment of FIGS. 1 to 3, this allows a plurality of such spreader devices to be inserted and extended between the upper and lower supports in order to provide some tension to the cables and to allow a fence panel to approximate its final dimensions prior to secure fixing in a desired location.

Such a spreader device can also be used to spread the upper and lower supports to allow insertion of brace bars. Normally it will be desired to separate the supports slightly more for insertion of the brace bars, than for other purposes (since resilience in the supports will, upon renewal of the spreader device can then be relied upon to retain the brace bars). Thus, a spreader device for insertion of brace bars may be slightly longer, in its extended configuration, than a spreader device for merely positioning the supports prior to securing. Alternatively, the same size of spreader device may be used but adjusted to a slightly longer size, for example, by rotation of the threaded stem 1113, or by selection of a different aperture 1124. As a further alternative, a small spacer may be provided between one of the contact portions 1112, 1122 and the respective support to provide the extra spacings.

It will be appreciated that as the lever member is moved from the first position to the second position, the first pivot pin 1140 crosses or at least reaches a line projected between the main pivot pin 1136 and the second pivot pin 1141. This “over centre” arrangement means that a compressive force on the device 1100 (or, as illustrated, a downwards force applied to the second pivot pin) will not tend to force the lever member 1130 towards its first position, but will, if anything, tend to retain the lever member 1130 in its second position. That is, the compressive force effectively locks the device in its extended configuration. To facilitate this arrangement, in the illustrated embodiment the main pivot pin 1136 is offset from the centre of the first body portion towards the side on which the first and second pivot pins are located. It will be appreciated that the spreader device provides considerable mechanical advantage in forcing the two supports apart. In the illustrated embodiment, the distance between the handle 1133 and the main pivot 1136 is about seven times the distance between the main pivot 1136 and the first pivot 1140 indicating a mechanical advantage of about seven (although it is appreciated that other factors will also influence this).

FIG. 14 is a schematic partial side elevation of an alternative embodiment of a spreader device, designated 1400, in an extended configuration. A lever member 1430 is pivotally attached to a first body portion 1410 by a pivot 1436. Although including a number of similarities to the embodiment of FIG. 11 to 13, rather than including a pivot and link mechanism in the embodiment of FIG. 14, first and second side plates (of which one 1434 is shown) are provided with cam surfaces 1435 to engage a bottom surface 1425 of a second body portion 1420, in order to force the second body portion 1420 away from the pivot 1436, and extend the device. The cam surface 1435 and the bottom surface 1425 are shaped so that with the device in its extended configuration (as illustrated) any compressive force is transmitted from the second body portion 1420 to the cam surface so that it is directed to the right-hand side of the pivot 1436. This allows a compressive force to effectively lock the device in its extended position.

It should be appreciated that the schematic embodiment of FIG. 14 is provided to be indicative of alternative embodiments of self-locking mechanisms for spreader devices and the illustrated shapes of the cam surface and follower are illustrative only.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

It is to be understood that, if any prior art publication is referred to herein, such reference does not constitute an admission that the publication forms a part of the common general knowledge in the art, in Australia or in any other country.

Modifications and improvements may be incorporated without departing from the scope of the present invention.

1. A tensioning system for tensioning cable comprising:
a cable spacing member with a plurality of cable spacing portions for spacing apart a plurality of runs of cable;
a support for supporting the cable spacing member;
one or more adjustable positioning members for positioning the cable spacing member relative to the support wherein, in use, adjustment of the one or more adjustable positioning members to position the cable spacing member relative to the support adjusts the tension in the runs of cable.

2. A tensioning system as claimed in claim 1, wherein adjustment of the one or more adjustable positioning members is adapted to move the cable spacing member in a direction substantially parallel to a longitudinal direction of the runs of cable.

3. A tensioning system as claimed in claim 1, wherein each cable spacing portion includes one or more apertures and/or slots in the cable spacing member.

4. A tensioning system as claimed in claim 3, wherein respective apertures or slots are spaced apart to space apart respective runs of cable.

5. A tensioning system as claimed in claim 1, wherein the cable spacing member includes at least three cable spacing portions.

6. A tensioning system as claimed in claim 5, wherein the cable spacing member includes four or more cable spacing portions.

7. A tensioning system as claimed in claim 1, wherein, in use, the cable spacing member is located inside the support.

8. A tensioning system as claimed in claim 7, wherein the support is generally tubular and includes one or more openings along the length thereof for runs of cable to pass through.

9. A tensioning system as claimed in claim 8, wherein the support includes one or more longitudinal slots for cables to pass through.

10. A tensioning system as claimed in claim 9, wherein the or each longitudinal slot is long compared to the radial dimensions of the support.

11. A tensioning system as claimed in claim 1, wherein the adjustable positioning members are adapted for manual operation.

12. A tensioning system as claimed in claim 11, wherein the adjustable positioning members are manually operable by use of a tool.

13. A tensioning system as claimed in claim 11, wherein at least one of the adjustable positioning members includes a mechanism which provides a mechanical advantage, so that applying an input force to operate the positioning member results in a greater force being applied to move the bar relative to the support.

14. A tensioning system as claimed in claim 13, wherein at least one of the adjustable positioning members includes a bolt or a bolt-like fastener.

15. A tensioning system as claimed in claim 7, wherein at least one adjustable positioning member extends from an external region of the support into an internal region of the support.

16. (canceled)

17. (canceled)

18. (canceled)

19. (canceled)

20. A tensioning system as claimed in claim 1, wherein one or more of the cable spacing portions includes a contour which extends from a lateral edge of the cable spacing member, the contour preferably comprising a laterally extending slot to allow lengths of cable to be introduced laterally into the cable spacing portions.

21. A tensioning system as claimed in claim 1, wherein the cable spacing member includes two or more parts, which may be coupled together, in use, to form a single cable spacing member.

22. A tensioning system as claimed in claim 21, wherein the parts are designed so that at least one of the parts is configured to receive lengths of cable into cable spacing portions before coupling with another part to form a single cable spacing member, and so that after coupling, separation of the lengths of cable from the cable spacing member is inhibited by the other part.

23. A tensioning system wherein a tensioning system as claimed in claim 1 is used for securing and applying a tensioning force to a first end of each run of cable and wherein positioning and/or securing means for the second end of each run of cable includes a tensioning system as claimed in claim 1.

24. A barrier including a tensioning system as claimed in claim 1.

25. A barrier as claimed in claim 24, wherein, in use, the barrier forms part or all of a fence or balustrade.

26. A barrier as claimed in claim 25, wherein, the barrier includes a support and a cable spacing member for supporting and applying a tensioning force to a first end of each of a plurality of runs of cable, and a secondary support for positioning and/or retaining a second end of each of a plurality of runs of cable.

27. A barrier as claimed in claim 26, wherein the barrier includes one or more bracing members for bracing apart the support and the secondary support.

28. A method of tensioning a plurality of runs of cable, comprising:
coupling at least one length of cable to a cable spacing member having cable spacing portions thereon for spacing apart a plurality of runs of cable, and coupling said at least one length of cable to a secondary cable spacing member having cable spacing portions thereon for spacing apart a plurality of runs of cable, in order to provide a plurality of runs of cable between the cable spacing member and the secondary cable spacing member;
locating the cable spacing member relative to a support;
providing one or more adjustable positioning members for adjustably positioning the cable spacing member relative to the support;
locating the secondary cable spacing member relative to a secondary support;
adjusting the one or more adjustable positioning members in order to tension the runs of cable.

29. A method as claimed in claim 28, wherein the method is a method of tensioning a plurality of runs of cable in forming a fence or similar barrier.

30. A method as claimed in claim 29, wherein locating the cable spacing member relative to a support comprises inserting the cable spacing member into a hollow support.

31. A method as claimed in claim 30, wherein the support is generally tubular and is provided with a longitudinal slot through which, in use, runs of cable extend from the cable spacing member to the outside of the support.

32. (canceled)

33. A method as claimed in claim 28, wherein the method includes using a spreader device to space apart the support and the secondary support prior to final adjustment of the adjustable positioning members.

34. A method as claimed in claim 28, wherein the method includes insertion of one or more bracing members between the support and the secondary support.

35. A method as claimed in claim 28, wherein the method includes forming a substantially rigid panel comprising a cable spacing member located relative to a support; a secondary cable spacing member located relative to a secondary support; a plurality of runs of cable; and one or more bracing members and/or spreader devices bracing apart the support and the secondary support.

36. (canceled)

37. A method as claimed in claim 35, wherein the method includes adjustment of the one or more adjustable positioning members after fixing the substantially rigid panel in said desired location.

38. A method as claimed in claim 35, wherein the substantially rigid panel includes one or more spreader devices but no bracing bars prior to fixing of the latter of the support and secondary support in the desired location, and the method includes subsequent insertion of one or more bracing bars between the support and secondary support and subsequent removal of the one or more spreader devices.

39. A method of tensioning a plurality of runs of cable, comprising:
providing a plurality of tensioning mechanisms, each tensioning mechanism including a spacing member for attachment of the end or respective first ends of one or more runs of cable;
connecting one or more ends of one or more runs of cable to each tensioning mechanism;
inserting each tensioning mechanism into a hollow support member;
providing at least one adjustable positioning member to form part of each tensioning mechanism, each adjustable positioning member extending from an outside to an inside of the associated hollow support member and engaging a spacing member, inside the hollow support member so that adjustment of the adjustable positioning member moves the associated spacing member relative to the hollow support in order to adjust the tension in at least one run of cable; and
adjusting adjustable positioning members to adjust tension in at least one run of cable.

40. A barrier including a tensioning system for tensioning cable, comprising:
a plurality of runs of cable which run between a first support and a second support;
a plurality of cable tensioning mechanisms, each tensioning mechanism comprising a spacing member for attachment of the end, or respective first ends, of one or more runs of cable, said spacing members being provided within at least one of the supports and wherein each spacing member has at least one associated adjustable positioning member for adjusting the position of the spacing member relative to the support; and
said adjustable positioning member extending from the outside of the associated support to the associated spacing member located within the support so that the tensioning mechanism can be operated from the outside of the support.

41. A barrier as claimed in claim 40, wherein at least one of the supports is a tubular member with a longitudinal slot through which runs of cable pass.

42. (canceled)

43. (canceled)

44. (canceled)

45. (canceled)

46. (canceled)
